(19) United States
(12) Patent Application Publication
(10) Pub. No.: US 2008/0174267 A1
(43) Pub. Date: Jul. 24, 2008

(54) Power transmission control device, power reception control device, non-contact power transmission system, power transmission device, power reception device and electronic instrument

(75) Inventors: Kota Onishi, Nagoya-shi (JP); Kentaro Yoda, Chino-shi (JP); Kuniharu Suzuki, Tokyo (JP); Hiroshi Kato, Yokohama City (JP); Katsuya Suzuki, Takasaki-shi (JP); Manabu Yamazaki, Hiratsuka-city (JP)

Correspondence Address: OLIFF & BERRIDGE, PLC, P.O. BOX 320850, ALEXANDRIA, VA, 22320-4850, US

(73) Assignees: SEIKO EPSON CORPORATION, TOKYO (JP); SONY ERICSSON MOBILE COMMUNICATIONS JAPAN, INC., TOKYO (JP)

(21) Appl. No.: 12/007,672

(22) Filed: Jan. 14, 2008

(30) Foreign Application Priority Data
Jan. 17, 2007 (JP) 2007-007995

(51) Int. Cl. H02J 7/00

(52) U.S. Cl. 320/108

(57) ABSTRACT

A power transmission control device provided in a power transmission device of a non-contact power transmission system includes a power-transmission-side control circuit that controls the power transmission device. When the power-transmission-side control circuit has detected that a battery included in the load has been fully charged, the power-transmission-side control circuit performs control of suspending normal power transmission to the power reception device and control of performing intermittent power transmission. When the power-transmission-side control circuit has detected that the battery requires recharging during an intermittent power transmission period, the power-transmission-side control circuit performs control of resuming normal power transmission to the power reception device. A power-reception-side control circuit that controls the power reception device performing control of transmitting a recharge command that indicates information relating to a recharge state of the battery to the power transmission device in an intermittent power transmission period.

Japanese Patent Application No. 2007-7995 filed on Jan. 17, 2007, is hereby incorporated by reference in its entirety.

### BACKGROUND OF THE INVENTION

The present invention relates to a power transmission control device, a power reception control device, a non-contact power transmission system, a power transmission device, a power reception device, an electronic instrument, and the like.

In recent years, non-contact power transmission (contactless power transmission) which utilizes electromagnetic induction to enable power transmission without metal-to-metal contact has attracted attention. As application examples of non-contact power transmission, charging a portable telephone, a household appliance (e.g., telephone handset), and the like has been proposed.

JP-A-6-339232 and JP-A-2006-60909 disclose related-art non-contact power transmission technologies. In JP-A-6-339232, when a secondary-side battery has been fully charged, the oscillation operation of a primary-side power supply section is stopped. JP-A-2006-60909 implements data transmission from a power reception device (secondary side) to a power transmission device (primary side) by means of load modulation.

However, JP-A-6-339232 and JP-A-2006-60909 do not take into account a mechanism for recharging a battery which has been fully charged.

### SUMMARY

According to one aspect of the invention, there is provided a power transmission control device provided in a power transmission device of a non-contact power transmission system, the non-contact power transmission system transmitting power from the power transmission device to a power reception device by electromagnetically coupling a primary coil and a secondary coil to transmit the power to a load of the power reception device, the power transmission control device comprising:

a power-transmission-side control circuit that controls the power transmission device,

when the power-transmission-side control circuit has detected that a battery included in the load has been fully charged, the power-transmission-side control circuit performing control of suspending normal power transmission to the power reception device and control of performing intermittent power transmission, and, when the power-transmission-side control circuit has detected that the battery requires recharging during an intermittent power transmission period, the power-transmission-side control circuit performing control of resuming the normal power transmission to the power reception device.

According to another aspect of the invention, there is provided a power reception control device provided in a power reception device of a non-contact power transmission system, the non-contact power transmission system transmitting power from a power transmission device to the power reception device by electromagnetically coupling a primary coil and a secondary coil to transmit the power to a load of the power reception device, the power reception control device comprising:

a power-reception-side control circuit that controls the power reception device; and

a recharge monitoring circuit that monitors a recharge state of a battery included in the load after the battery has been fully charged,

when the battery has been fully charged and the power transmission device has suspended normal power transmission and performed intermittent power transmission, the power-reception-side control circuit performing control of transmitting a recharge command to the power transmission device in an intermittent power transmission period, the recharge command indicating information relating to the recharge state of the battery.

According to another aspect of the invention, there is provided a non-contact power transmission system comprising a power transmission device and a power reception device, the non-contact power transmission system transmitting power from the power transmission device to the power reception device by electromagnetically coupling a primary coil and a secondary coil to transmit the power to a load of the power reception device,

the power transmission device including a power-transmission-side control circuit that controls the power transmission device;

the power reception device including:

a power-reception-side control circuit that controls the power reception device;

a full-charge detection circuit that detects whether or not the battery has been fully charged; and

a recharge monitoring circuit that monitors a recharge state of the battery after the battery has been fully charged;

when the battery has been fully charged, the power-reception-side control circuit performing control of transmitting a full-charge command that indicates that the battery has been fully charged to the power transmission device, and stopping outputting a voltage to a charge control device that controls charging the battery;

when the power-transmission-side control circuit has received the full-charge command from the power reception device during normal power transmission to the power reception device, the power-transmission-side control circuit performing control of suspending power transmission to the power reception device during a first period, and performing control of transmitting a recharge detection command to the power reception device during an intermittent power transmission period after resuming power transmission, the recharge detection command instructing the power reception device to detect the recharge state of the battery; and

the power-reception-side control circuit performing control of receiving the recharge detection command in the intermittent power transmission period, and performing control of transmitting a recharge command that indicates information relating to the recharge state of the battery to the power transmission device.

According to another aspect of the invention, there is provided a power transmission device comprising:

one of the above power transmission control devices; and

a power transmission section that generates an alternating-current voltage and supplies the alternating voltage to the primary coil.

According to another aspect of the invention, there is provided a power reception device comprising:

one of the above power reception control devices; and

a power receiving section that converts an induced voltage in the secondary coil into a direct voltage.

According to another aspect of the invention, there is provided an electronic instrument comprising the above power transmission device.

According to another aspect of the invention, there is provided an electronic instrument comprising:

the above power reception device; and

a load, power being supplied to the load from the power reception device.

### BRIEF DESCRIPTION OF THE SEVERAL VIEWS OF THE DRAWING

FIGS. 1A and 1B are views illustrative of non-contact power transmission.

FIG. 2 shows a configuration example of a power transmission device, a power transmission control device, a power reception device, and a power reception control device according to one embodiment of the invention.

FIGS. 3A and 3B are views illustrative of data transfer by means of frequency modulation and load modulation.

FIG. 4 is a block diagram showing the main portion of a power transmission device, a power transmission control device, a power reception device, and a power reception control device.

FIGS. 5A and 5B are sequence diagrams illustrative of the operation according to one embodiment of the invention.

FIG. 6 is a flowchart illustrative of a detailed operation according to one embodiment of the invention.

FIG. 7 shows a configuration example of a waveform detection circuit.

FIGS. 8A and 8B show configuration examples of a recharge monitoring circuit.

FIG. 9 is a view illustrative of a modification according to one embodiment of the invention.

### DETAILED DESCRIPTION OF THE EMBODIMENT

Some aspects of the invention may provide a power transmission control device, a power reception control device, a non-contact power transmission system, a power transmission device, a power reception device, and an electronic instrument which enable a battery to be recharged while minimizing unnecessary power consumption.

According to one embodiment of the invention, there is provided a power transmission control device provided in a power transmission device of a non-contact power transmission system, the non-contact power transmission system transmitting power from the power transmission device to a power reception device by electromagnetically coupling a primary coil and a secondary coil to transmit the power to a load of the power reception device, the power transmission control device comprising:

a power-transmission-side control circuit that controls the power transmission device,

when the power-transmission-side control circuit has detected that a battery included in the load has been fully charged, the power-transmission-side control circuit performing control of suspending normal power transmission to the power reception device and control of performing intermittent power transmission, and, when the power-transmission-side control circuit has detected that the battery requires recharging during an intermittent power transmission period, the power-transmission-side control circuit performing control of resuming the normal power transmission to the power reception device.

According to this embodiment, when it has been detected that the battery has been fully charged, normal power transmission is suspended and intermittent power transmission is performed. When it has been detected that the battery requires recharging during the intermittent power transmission period, normal power transmission from the power-transmission-side device to the power-reception-side device is resumed so that the battery is recharged. According to this embodiment, since normal power transmission is suspended when it has been detected that the battery has been fully charged and only intermittent power transmission is then performed, a standby current in a post-full-charge standby mode can be significantly reduced, whereby unnecessary power consumption can be minimized. Moreover, since periodic intermittent power transmission is performed and whether or not the battery requires recharging is checked, the battery can be efficiently and reliably recharged.

In the power transmission control device according to this embodiment,

the power-transmission-side control circuit may perform control of suspending power transmission to the power reception device during a first period when the power-transmission-side control circuit has received a full-charge command from the power reception device during the normal power transmission to the power reception device, the full-charge command indicating that the battery has been fully charged, and may perform control of transmitting a recharge detection command to the power reception device during the intermittent power transmission period after resuming power transmission, the recharge detection command instructing the power reception device to detect a recharge state of the battery.

According to this configuration, the power-transmission-side device can detect that the battery has been fully charged by receiving the full-charge command from the power-reception-side device. Power consumption can be reduced by suspending power transmission during the first period after detecting that the battery has been fully charged. Since the power-transmission-side device transmits the recharge detection command to the power-reception-side device during the intermittent power transmission period, the power-reception-side device can start detection of the recharge state of the battery by receiving the recharge detection command even when the power-reception-side device cannot store information relating to relating to the full-charge state or the recharge state.

In the power transmission control device according to this embodiment,

when the power-transmission-side control circuit has received a recharge command that indicates information relating to the recharge state of the battery from the power reception device and determined that the battery requires recharging, the power-transmission-side control circuit may perform control of resuming the normal power transmission to the power reception device.

According to this configuration, the power-transmission-side device can detect whether or not the battery requires recharging by receiving the recharge command from the power-reception-side device. Therefore, the power-transmission-side can determine whether or not to resume normal power transmission.

In the power transmission control device according to this embodiment,

the power-transmission-side control circuit may perform control of suspending power transmission to the power reception device during the first period when the power-transmission-side control circuit has not received the recharge command from the power reception device until a second period has expired after transmitting the recharge detection command to the power reception device, and may perform control of transmitting the recharge detection command to the power reception device during the intermittent power transmission period after resuming power transmission.

According to this configuration, the power-transmission-side device can suspend power transmission and perform intermittent power transmission merely by waiting for expiration of the second period, whereby the process can be simplified.

In the power transmission control device according to this embodiment,

the power-transmission-side control circuit may perform control of resetting a full-charge flag and starting the normal power transmission to the power reception device after ID authentication between the power transmission device and the power reception device has been completed, setting the full-charge flag when the power-transmission-side control circuit has received the full-charge command from the power reception device, and may reset the full-charge flag when resuming the normal power transmission to recharge the battery.

According to this configuration, the power-transmission-side device which can store information when power transmission is suspended can appropriately control the sequence when the battery has been fully charged or is recharged using the stored full-charge flag.

According to another embodiment of the invention, there is provided a power reception control device provided in a power reception device of a non-contact power transmission system, the non-contact power transmission system transmitting power from a power transmission device to the power reception device by electromagnetically coupling a primary coil and a secondary coil to transmit the power to a load of the power reception device, the power reception control device comprising:

a power-reception-side control circuit that controls the power reception device; and

a recharge monitoring circuit that monitors a recharge state of a battery included in the load after the battery has been fully charged,

when the battery has been fully charged and the power transmission device has suspended normal power transmission and performed intermittent power transmission, the power-reception-side control circuit performing control of transmitting a recharge command to the power transmission device in an intermittent power transmission period, the recharge command indicating information relating to the recharge state of the battery.

According to this embodiment, when the battery has been fully charged and the power-transmission-side device has suspended normal power transmission and performed intermittent power transmission, the recharge command is transmitted from the power-reception-side device to the power-transmission-side device during the intermittent power transmission period. The power-transmission-side device can be provided with information relating to the recharge state of the battery (e.g., whether or not recharging is necessary or the battery voltage) based on the recharge command, whereby the power-transmission-side device can appropriately control the sequence of recharging the battery. Therefore, the battery can be efficiently recharged while minimizing unnecessary power consumption.

In the power reception control device according to this embodiment,

the power reception control device may further include a full-charge detection circuit that detects whether or not the battery has been fully charged,

when the battery has been fully charged, the power-reception-side control circuit may perform control of transmitting a full-charge command that indicates that the battery has been fully charged to the power transmission device, and may stop outputting a voltage to a charge control device that controls charging the battery.

According to this configuration, the power-reception-side device can notify the power-transmission-side device of the full-charge state of the battery using the full-charge command, whereby the power-transmission-side device can suspend normal power transmission. Moreover, the standby current of the charge control device can be reduced by stopping outputting the voltage to the charge control device, whereby power consumption can be further reduced.

In the power reception control device according to this embodiment,

the power reception control device may be reset when power transmission from the power transmission device has been suspended after transmitting the full-charge command; and

when the power-reception-side control circuit has received a recharge detection command from the power transmission device after a reset state of the power reception control device has been canceled by intermittent power transmission from the power transmission device, the recharge detection command instructing the power reception device to detect the recharge state of the battery, the power-reception-side control circuit may monitor the recharge state of the battery.

According to this configuration, even if the power-reception-side device is reset state due to suspension of power transmission so that the power-reception-side device cannot store information relating to the full-charge state or the recharge state, the power-reception-side device can again monitor the recharge state of the battery based on the recharge detection command from the power-transmission-side device.

In the power reception control device according to this embodiment,

the power reception control device may further include a terminal, a battery voltage or a detection signal for monitoring the recharge state of the battery being input to the terminal.

This enables the recharge state of the battery to be efficiently monitored based on the battery voltage or the detection signal input through the terminal.

According to another embodiment of the invention, there is provided a non-contact power transmission system comprising a power transmission device and a power reception device, the non-contact power transmission system transmitting power from the power transmission device to the power reception device by electromagnetically coupling a primary coil and a secondary coil to transmit the power to a load of the power reception device,

the power transmission device including a power-transmission-side control circuit that controls the power transmission device;

the power reception device including:

a power-reception-side control circuit that controls the power reception device;

a full-charge detection circuit that detects whether or not the battery has been fully charged; and

a recharge monitoring circuit that monitors a recharge state of the battery after the battery has been fully charged;

when the battery has been fully charged, the power-reception-side control circuit performing control of transmitting a full-charge command that indicates that the battery has been fully charged to the power transmission device, and stopping outputting a voltage to a charge control device that controls charging the battery;

when the power-transmission-side control circuit has received the full-charge command from the power reception device during normal power transmission to the power reception device, the power-transmission-side control circuit performing control of suspending power transmission to the power reception device during a first period, and performing control of transmitting a recharge detection command to the power reception device during an intermittent power transmission period after resuming power transmission, the recharge detection command instructing the power reception device to detect the recharge state of the battery; and

the power-reception-side control circuit performing control of receiving the recharge detection command in the intermittent power transmission period, and performing control of transmitting a recharge command that indicates information relating to the recharge state of the battery to the power transmission device.

According to this embodiment, the power-reception-side device can notify the power-transmission-side device of the full-charge state of the battery using the full-charge command, whereby the power-transmission-side device can suspend normal power transmission. Moreover, the standby current of the charge control device can be reduced by stopping outputting the voltage to the charge control device. The power-transmission-side device can detect that the battery has been fully charged by receiving the full-charge command from the power-reception-side device. Power consumption can be reduced by suspending power transmission during the first period after detecting that the battery has been fully charged. Since the power-transmission-side device transmits the recharge detection command to the power-reception-side device during the intermittent power transmission period, the power-reception-side device can start monitoring the recharge state of the battery based on the recharge detection command even when the power-reception-side device cannot store information relating to relating to the full-charge state or the recharge state.

In the non-contact power transmission system device according to this embodiment,

the power-transmission-side control circuit may perform control of suspending power transmission to the power reception device during the first period when the power-transmission-side control circuit has not received the recharge command from the power reception device until a second period has expired after transmitting the recharge detection command to the power reception device, and may perform control of transmitting the recharge detection command to the power reception device during an intermittent power transmission period after resuming power transmission.

According to another embodiment of the invention, there is provided a power transmission device comprising:

one of the above power transmission control devices; and

a power transmission section that generates an alternating-current voltage and supplies the alternating voltage to the primary coil.

According to another embodiment of the invention, there is provided a power reception device comprising:

one of the above power reception control devices; and

a power receiving section that converts an induced voltage in the secondary coil into a direct voltage.

According to another embodiment of the invention, there is provided an electronic instrument comprising the above power transmission device.

According to another embodiment of the invention, there is provided an electronic instrument comprising:

the above power reception device; and

a load, power being supplied to the load from the power reception device.

Preferred embodiments of the invention are described in detail below. Note that the embodiments described below do not in any way limit the scope of the invention defined by the claims laid out herein. Note that all elements of the embodiments described below should not necessarily be taken as essential requirements for the invention.

1. Electronic Instrument

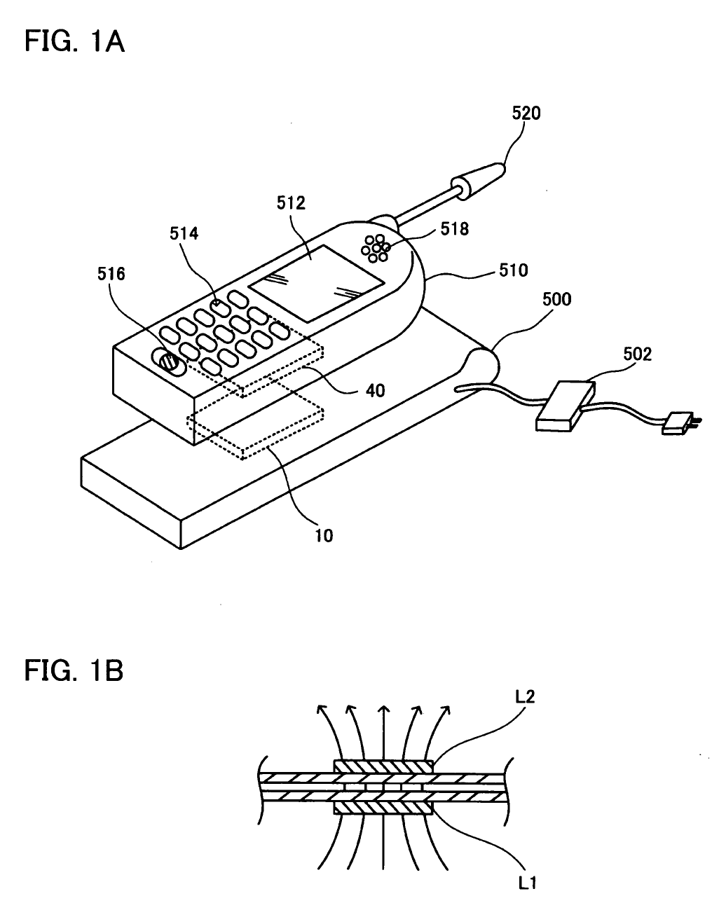

FIG. 1A shows examples of an electronic instrument to which a non-contact power transmission method according to one embodiment of the invention is applied. A charger 500 (cradle) (i.e., electronic instrument) includes a power transmission device 10. A portable telephone 510 (i.e., electronic instrument) includes a power reception device 40. The portable telephone 510 also includes a display section 512 such as an LCD, an operation section 514 which includes a button or the like, a microphone 516 (sound input section), a speaker 518 (sound output section), and an antenna 520.

Power is supplied to the charger 500 through an AC adaptor 502. The power supplied to the charger 500 is transmitted from the power transmission device 10 to the power reception device 40 by means of non-contact power transmission. This makes it possible to charge a battery of the portable telephone 510 or operate a device provided in the portable telephone 510.

The electronic instrument to which this embodiment is applied is not limited to the portable telephone 510. For example, this embodiment may be applied to various electronic instruments such as a wristwatch, a cordless telephone, a shaver, an electric toothbrush, a wrist computer, a handy terminal, a portable information terminal, and a power-assisted bicycle.

As schematically shown in FIG. 1B, power transmission from the power transmission device 10 to the power reception device 40 is implemented by electromagnetically coupling a primary coil L1 (transmitting coil) provided in the power transmission device 10 and a secondary coil L2 (receiving coil) provided in the power reception device 40 to form a power transmission transformer. This enables non-contact power transmission.

2. Power Transmission Device and Power Reception Device

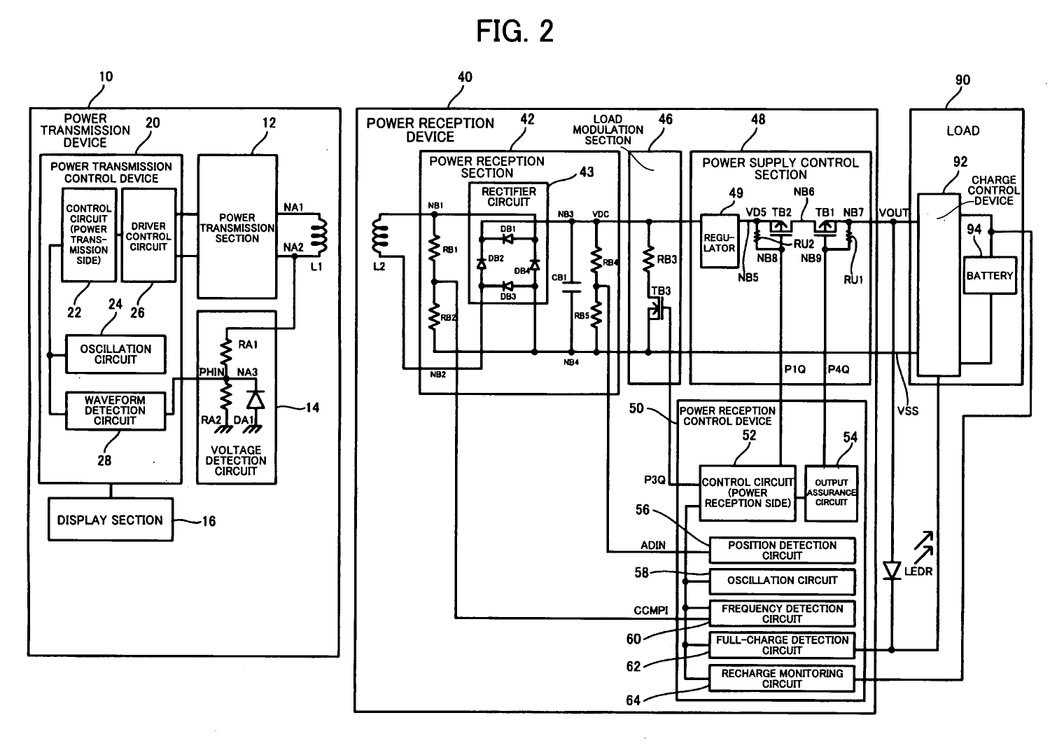

FIG. 2 shows a configuration example of a power transmission device 10, a power transmission control device 20, a power reception device 40, and a power reception control device 50 according to this embodiment. A power-transmission-side electronic instrument such as the charger 500 shown in FIG. 1A includes at least the power transmission device 10 shown in FIG. 2. A power-receiving-side electronic instrument such as the portable telephone 510 includes at least the power reception device 40 and a load 90 (actual load). The configuration shown in FIG. 2 implements a non-contact power transmission (contactless power transmission) system in which power is transmitted from the power transmission device 10 to the power reception device 40 by electromagnetically coupling the primary coil L1 and the secondary coil L2 and power (voltage VOUT) is supplied to the load 90 from a voltage output node NB7 of the power reception device 40.

The power transmission device 10 (power transmission module or primary module) may include the primary coil L1, a power transmission section 12, a voltage detection circuit 14, a display section 16, and the power transmission control device 20. The power transmission device 10 and the power transmission control device 20 are not limited to the configuration shown in FIG. 2. Various modifications may be made such as omitting some elements (e.g., display section and voltage detection circuit), adding other elements, or changing the connection relationship.

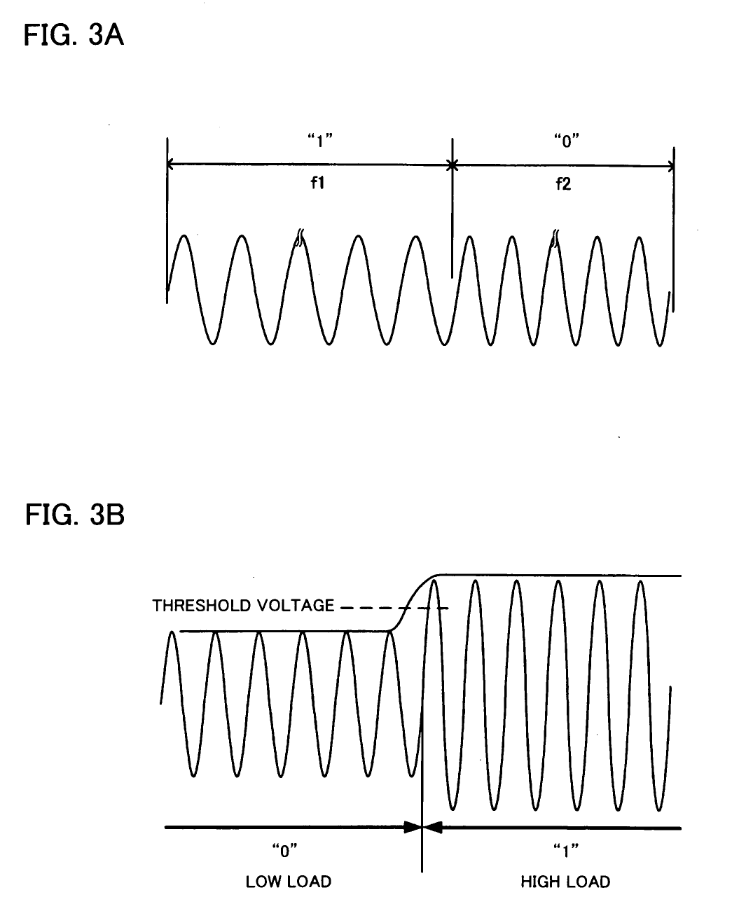

The power transmission section 12 generates an alternating-current voltage at a given frequency during power transmission, and generates an alternating-current voltage at a frequency which differs depending on data during data transfer. The power transmission section 12 supplies the generated alternating-current voltage to the primary coil L1. As shown in FIG. 3A, the power transmission section 12 generates an alternating-current voltage at a frequency f1 when transmitting data “1” to the power reception device 40, and generates an alternating-current voltage at a frequency f2 when transmitting data “0” to the power reception device 40, for example. The power transmission section 12 may include a first power transmission driver which drives one end of the primary coil L1, a second power transmission driver which drives the other end of the primary coil L1, and at least one capacitor which forms a resonant circuit together with the primary coil L1.

Each of the first and second power transmission drivers included in the power transmission section 12 is an inverter circuit (buffer circuit) which includes a power MOS transistor, for example, and is controlled by a driver control circuit 26 of the power transmission control device 20.

The primary coil L1 (power-transmission-side coil) is electromagnetically coupled with the secondary coil L2 (power-receiving-side coil) to form a power transmission transformer. For example, when power transmission is necessary, the portable telephone 510 is placed on the charger 500 so that a magnetic flux of the primary coil L1 passes through the secondary coil L2, as shown in FIGS. 1A and 1B. When power transmission is unnecessary, the charger 500 and the portable telephone 510 are physically separated so that a magnetic flux of the primary coil L1 does not pass through the secondary coil L2.

The voltage detection circuit 14 is a circuit which detects the induced voltage in the primary coil L1. The voltage detection circuit 14 includes resistors RA1 and RA2 and a diode DAI provided between a connection node NA3 of the resistors RA1 and RA2 and GND (low-potential-side power supply in a broad sense), for example. Specifically, a signal PHIN obtained by dividing the induced voltage in the primary coil L1 using the resistors RA1 and RA2 is input to a waveform detection circuit 28 of the power transmission control device 20.

The display section 16 displays the state (e.g., power transmission or ID authentication) of the non-contact power transmission system using a color, an image, or the like. The display section 16 is implemented by an LED, an LCD, or the like.

The power transmission control device 20 is a device which controls the power transmission device 10. The power transmission control device 20 may be implemented by an integrated circuit device (IC) or the like. The power transmission control device 20 may include a control circuit 22 (power transmission side), an oscillation circuit 24, a driver control circuit 26, the waveform detection circuit 28.

The control circuit 22 (control section) controls the power transmission device 10 and the power transmission control device 20. The control circuit 22 may be implemented by a gate array, a microcomputer, or the like. Specifically, the control circuit 22 performs sequence control and a determination process necessary for power transmission, load detection, frequency modulation, foreign object detection, detachment detection, and the like.

The oscillation circuit 24 includes a crystal oscillation circuit, for example. The oscillation circuit 24 generates a primary-side clock signal. The driver control circuit 26 generates a control signal at a desired frequency based on the clock signal generated by the oscillation circuit 24, a frequency setting signal from the control circuit 22, and the like, and outputs the generated control signal to the first and second power transmission drivers of the power transmission section 12 to control the first and second power transmission drivers.

The waveform detection circuit 28 monitors the waveform of the signal PHIN which corresponds to the induced voltage at one end of the primary coil L1, and performs load detection, foreign object detection, and the like. For example, when a load modulation section 46 of the power reception device 40 modulates load in order to transmit data to the power transmission device 10, the signal waveform of the induced voltage in the primary coil L1 changes as shown in FIG. 3B. Specifically, the amplitude (peak voltage) of the signal waveform decreases when the load modulation section 46 reduces load in order to transmit data “0”, and increases when the load modulation section 46 increases load in order to transmit data “1”. Therefore, the waveform detection circuit 28 can determine whether the data from the power reception device 40 is “0” or “1” by determining whether or not the peak voltage has exceeded a threshold voltage by performing a peak-hold process on the signal waveform of the induced voltage, for example. Note that the waveform detection method is not limited to the method shown in FIGS. 3A and 3B. For example, the waveform detection circuit 28 may determine whether the power-reception-side load has increased or decreased using a physical quantity other than the peak voltage.

The power reception device 40 (power reception module or secondary module) may include the secondary coil L2, a power reception section 42, the load modulation section 46, a power supply control section 48, and a power reception control device 50. The power reception device 40 and the power reception control device 50 are not limited to the configuration shown in FIG. 2. Various modifications may be made such as omitting some elements, adding other elements, or changing the connection relationship.

The power reception section 42 converts an alternating-current induced voltage in the secondary coil L2 into a direct-current voltage. A rectifier circuit 43 included in the power reception section 42 converts the alternating-current induced voltage. The rectifier circuit 43 includes diodes DB1 to DB4. The diode DB1 is provided between a node NB1 at one end of the secondary coil L2 and a direct-current voltage VDC generation node NB3, the diode DB2 is provided between the node NB3 and a node NB2 at the other end of the secondary coil L2, the diode DB3 is provided between the node NB2 and a node NB4 (VSS), and the diode DB4 is provided between the nodes NB4 and NB1.

Resistors RB1 and RB2 of the power reception section 42 are provided between the nodes NB1 and NB4. A signal CCMPI obtained by dividing the voltage between the nodes NB1 and NB4 using the resistors RB1 and RB2 is input to a frequency detection circuit 60 of the power reception control device 50.

A capacitor CB1 and resistors RB4 and RB5 of the power reception section 42 are provided between the node NB3 (direct-current voltage VDC) and the node NB4 (VSS). A signal ADIN obtained by dividing the voltage between the nodes NB3 and NB4 using the resistors RB4 and RB5 is input to a position detection circuit 56 of the power reception control device 50.

The load modulation section 46 performs a load modulation process. Specifically, when the power reception device 40 transmits desired data to the power transmission device 10, the load modulation section 46 variably changes the load of the load modulation section 46 (secondary side) depending on transmission data to change the signal waveform of the induced voltage in the primary coil L1 as shown in FIG. 3B. The load modulation section 46 includes a resistor RB3 and a transistor TB3 (N-type CMOS transistor) provided in series between the nodes NB3 and NB4. The transistor TB3 is ON/OFF-controlled based on a signal P3Q from a control circuit 52 of the power reception control device 50. When performing load modulation by ON/OFF-controlling the transistor TB3, transistors TB1 and TB2 of the power supply control section 48 are turned OFF so that the load 90 is not electrically connected to the power reception device 40.

For example, when reducing the secondary-side load (high impedance) in order to transmit data “0”, as shown in FIG. 3B, the signal P3Q is set at the L level so that the transistor TB3 is turned OFF. As a result, the load of the load modulation section 46 becomes almost infinite (no load). On the other hand, when increasing the secondary-side load (low impedance) in order to transmit data “1”, the signal P3Q is set at the H level so that the transistor TB3 is turned ON. As a result, the load of the load modulation section 46 becomes the resistor RB3 (high load).

The power supply control section 48 controls power supplied to the load 90. A regulator 49 regulates the voltage level of the direct-current voltage VDC obtained by conversion by the rectifier circuit 43 to generate a power supply voltage VD5 (e.g., 5 V). The power reception control device 50 operates based on the power supply voltage VD5 supplied from the power supply control section 48, for example.

The transistor TB2 (P-type CMOS transistor) is provided between a node NB5 (power supply voltage VD5 generation node) (output node of the regulator 49) and the transistor TB1 (node NB6), and is controlled based on a signal P1Q from the control circuit 52 of the power reception control device 50. Specifically, the transistor TB2 is turned ON when ID authentication has been completed (established) and normal power transmission is performed, and is turned OFF during load modulation or the like. A pull-up resistor RU2 is provided between the power supply voltage generation node NB5 and a node NB8 of the gate of the transistor TB2.

The transistor TB1 (P-type CMOS transistor) is provided between the transistor TB2 (node NB6) and the voltage VOUT output node NB7, and is controlled based on a signal P4Q from an output assurance circuit 54. Specifically, the transistor TB1 is turned ON when ID authentication has been completed and normal power transmission is performed. The transistor TB1 is turned OFF when connection of an AC adaptor has been detected or the power supply voltage VD5 is lower than the operation lower limit voltage of the power reception control device 50 (control circuit 52), for example. A pull-up resistor RU1 is provided between the voltage output node NB7 and a node NB9 of the gate of the transistor TB1.

The power reception control device 50 controls the power reception device 40. The power reception control device 50 may be implemented by an integrated circuit device (IC) or the like. The power reception control device 50 may operate based on the power supply voltage VD5 generated from the induced voltage in the secondary coil L2. The power reception control device 50 may include the (power-reception-side) control circuit 52, the output assurance circuit 54, the position detection circuit 56, an oscillation circuit 58, the frequency detection circuit 60, a full-charge detection circuit 62, and a recharge monitoring circuit 64.

The control circuit 52 (control section) controls the power reception device 40 and the power reception control device 50. The control circuit 52 may be implemented by a gate array, a microcomputer, or the like. Specifically, the control circuit 22 performs sequence control and a determination process necessary for ID authentication, position detection, frequency detection, load modulation, full-charge detection, recharge monitoring, and the like.

The output assurance circuit 54 assures the output from the power reception device 40 when the voltage is low (0 V). Specifically, when connection of an AC adaptor has been detected or the power supply voltage VD5 is lower than the operation lower limit voltage, for example, the output assurance circuit 54 causes the transistor TB1 to be turned OFF to prevent a backward current flow from the voltage output node NB7 to the power reception device 40.

The position detection circuit 56 monitors the waveform of the signal ADIN which corresponds to the waveform of the induced voltage in the secondary coil L2, and determines whether or not the positional relationship between the primary coil L1 and the secondary coil L2 is appropriate. Specifically, the position detection circuit 56 converts the signal ADIN into a binary value using a comparator to determine whether or not the positional relationship between the primary coil L1 and the secondary coil L2 is appropriate.

The oscillation circuit 58 includes a CR oscillation circuit, for example. The oscillation circuit 58 generates a secondary-side clock signal. The frequency detection circuit 60 detects the frequency (f1 or f2) of the signal CCMPI, and determines whether the data transmitted from the power transmission device 10 is “1” or “0”, as shown in FIG. 3A.

The full-charge detection circuit 62 (charge detection circuit) detects whether or not the battery 94 of the load 90 has been fully charged (charged). Specifically, the full-charge detection circuit 62 detects whether or not the battery 94 has been fully charged by detecting whether a light-emitting device LEDR used to display the charge state is turned ON or OFF, for example. The full-charge detection circuit 62 determines that the battery 94 has been fully charged (charging has been completed) when the light-emitting device LEDR has been turned OFF for a given period of time (e.g., five seconds).

The recharge monitoring circuit 64 (charge monitoring circuit) monitors the recharge state of the battery 94 of the load 90 after the battery 94 has been fully charged. Specifically, after the battery 94 has been fully charged, a battery voltage VBAT gradually decreases. The recharge monitoring circuit 64 monitors whether or not the battery voltage VBAT has become equal to or less than a recharge voltage to monitor whether or not the battery 94 requires recharging, for example. Or the recharge monitoring circuit 64 monitors the battery voltage VBAT in order to notify the power transmission device 10 of the battery voltage VBAT.

The load 90 includes a charge control device 92 which controls charging the battery 94 and the like. The charge control device 92 (charge control IC) may be implemented by an integrated circuit device or the like. The battery 94 may be provided with the function of the charge control device 92 (e.g., smart battery). When the battery 94 outputs a detection signal upon detection of a recharge state, the recharge monitoring circuit 64 may monitor the detection signal.

3. Battery Recharging Method

When the portable telephone 510 is placed on the charger 500, as shown in FIG. 1A, and power is transmitted from the power transmission device 10 to the power reception device 40 to charge the battery 94 (storage battery), the battery 94 is fully charged. The battery voltage (charge voltage) of the battery 94 then gradually decreases so that the battery 94 requires recharging. When the battery 94 requires recharging, it is desirable to supply power from the power transmission device 10 to the power reception device 40 to recharge the battery 94.

In order to enable the charge control device 92 to detect whether or not the battery 94 requires recharging, it is necessary to maintain the charge control device 92 in an operating state by supplying power (power supply voltage) to the charge control device 92 after the battery 94 has been fully charged. Specifically, power must be successively supplied from the power transmission device 10 to the power reception device 40 after the battery has been fully charged so that the charge control device 92 is not reset. Therefore, unnecessary power is transmitted from the power transmission device 10 to the power reception device 40 although the battery 94 is not charged, whereby a standby current of the non-contact power transmission system cannot be reduced to a large extent.

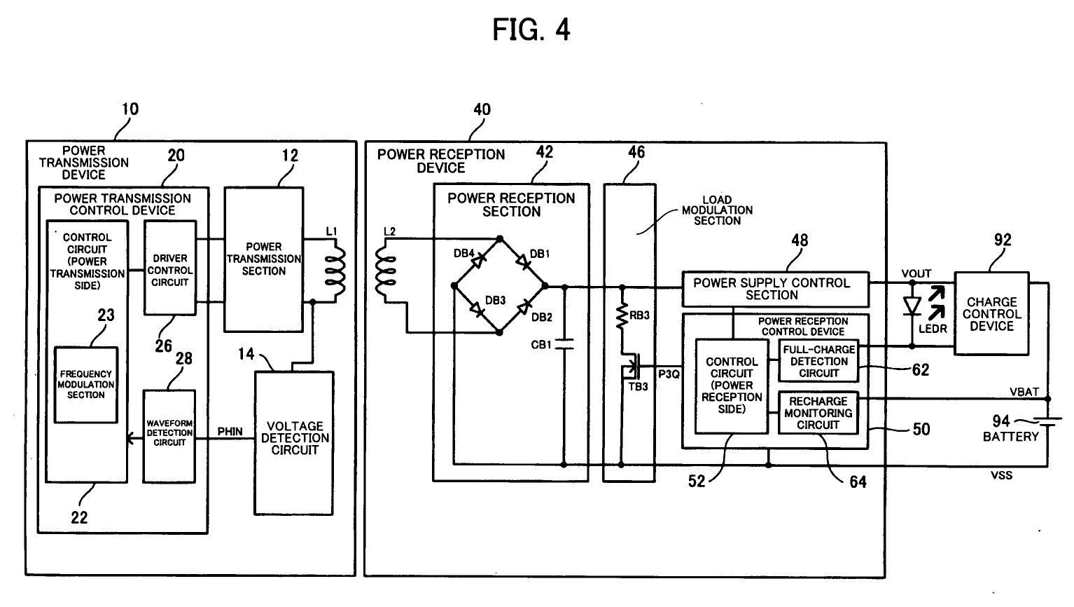

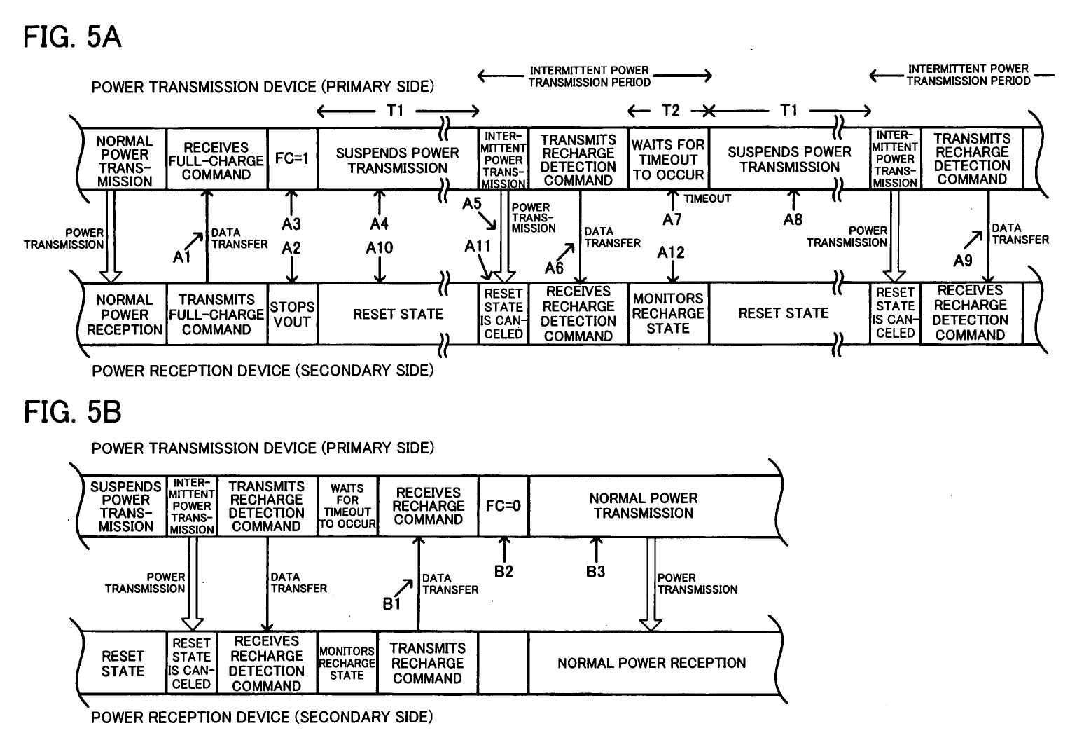

A recharging method according to this embodiment which solves such a problem is described below with reference to FIGS. 4, 5A, and 5B. FIG. 4 is a block diagram showing the main portion of the power transmission device 10, the power transmission control device 20, the power reception device 40, and the power reception control device 50 according to this embodiment. FIGS. 5A and 5B are sequence diagrams illustrative of the operation according to this embodiment.

In the recharging method according to this embodiment, a post-full-charge standby mode occurs when the battery 94 has been fully charged. In the post-full-charge standby mode, the primary-side instrument (power transmission device 10) intermittently transmits power to the secondary-side instrument (power reception device 40) while notifying the secondary-side instrument that the post-full-charge standby mode has occurred. When removal of the secondary-side instrument has been detected during power transmission, the primary-side instrument transitions to a normal standby mode. When the secondary-side instrument has been notified that the post-full-charge standby mode has occurred, the secondary-side instrument checks the battery voltage VBAT. When the battery voltage VBAT is equal to or less than the recharge voltage (e.g., 3.9 V), the secondary-side instrument determines that the battery 94 requires recharging. In this case, power transmission from the primary-side instrument to the secondary-side instrument is resumed to recharge the battery 94. The post-full-charge standby mode is canceled at this time. When the battery voltage VBAT is higher than the recharge voltage, the post-full-charge standby mode is maintained.

Specifically, when the power reception control device 50 has detected that the battery 94 of the load has been fully charged, the power-transmission-side control circuit 22 shown in FIG. 4 suspends normal power transmission to the power reception device 40 and intermittently transmits power to the power reception device 40. Specifically, a long power transmission suspension first period T1 and a short intermittent power transmission period are repeated. The first period T1 may be a constant period (e.g., one second), or may be a variable period which changes corresponding to the battery voltage VBAT or the like. When the power reception control device 50 has detected that the battery 94 is in a recharge state during the intermittent power transmission period, the power-transmission-side control circuit 22 resumes normal power transmission to the power reception device 40.

When the battery 94 has been fully charged so that the power transmission device 10 has suspended normal power transmission and then intermittently transmitted power, the power-reception-side control circuit 52 transmits a recharge command which indicates information relating to the recharge state of the battery 94 to the power transmission device 10 in the intermittent power transmission period. In this case, the full-charge state of the battery 94 is detected by the full-charge detection circuit 62, and the recharge state of the battery 94 is monitored by the recharge monitoring circuit 64. The term “information relating to the recharge state” refers to information used to determine whether or not the battery 94 has been in a recharge state (requires recharging), and includes information relating to whether or not the battery 94 requires recharging and information relating to the battery voltage VBAT after the battery 94 has been fully charged.

Specifically, as indicated by A1 in FIG. 5A, when the battery 94 has been fully charged the power-reception-side control circuit 52 transmits a full-charge command (full-charge information) which indicates that the battery 94 has been fully charged to the power transmission device 10 by means of load modulation performed by the load modulation section 46, for example. As indicated by A2, the control circuit 52 then stops outputting (supplying) the voltage VOUT to the charge control device 92. For example, the control circuit 52 determines that the battery 94 has been fully charged (charging has been completed) when the full-charge detection circuit 62 has detected that the light-emitting device LEDR used to display the charge state has been turned OFF for five seconds, for example. The control circuit 52 then generates a frame for transmitting the full-charge command, and transmits the generated frame to the power transmission device 10 by means of load modulation by controlling a signal P3Q.

When the power-transmission-side control circuit 22 has receives the full-charge command during normal power transmission to the power reception device 40, the control circuit 22 sets a full-charge flag FC at 1, as indicated by A3 in FIG. 5A, and suspends power transmission to the power reception device 40 for the first period T1 (e.g., one second), as indicated by A4. The control circuit 22 then resumes power transmission (intermittent power transmission), as indicated by A5. The control circuit 22 transmits a recharge detection command which instructs the power reception device 40 to perform detection of the recharge state of the battery 94 (detection of whether or not the battery 94 requires recharging or detection of the battery voltage after the battery 94 has been fully charged) in the intermittent power transmission period after resuming power transmission, as indicated by A6. For example, the frequency modulation section 23 shown in FIG. 4 performs frequency modulation to generate a frame of the recharge detection command using the method described with reference to FIG. 3A, and the control circuit 22 transmits the generated frame. When the control circuit 22 has not received the recharge command from the power reception device 40 until a second period T2 (e.g., 30 msec; T2<T1) expires after the control circuit 22 has transmitted the recharge detection command, the control circuit 22 determines that a timeout has occurred, as indicated by A7. When a timeout has occurred, the control circuit 22 again suspends power transmission to the power reception device 40 for the first period T1, as indicated by A8, and again transmits the recharge detection command to the power reception device 40 in the intermittent power transmission period after resuming power transmission, as indicated by A9.

As indicated by A10 in FIG. 5A, when power transmission from the power transmission device 10 has been suspended after the power reception control device 50 has transmitted the full-charge command, the power reception control device 50 is reset. Specifically, the power supply voltage becomes 0 V since power is not supplied from the power transmission device 10, whereby the power reception control device 50 is reset. When the power-reception-side control circuit 52 has received the recharge detection command from the power transmission device 10 after the reset state has been canceled by intermittent power transmission from the power transmission device 10, as indicated by A11, the power-reception-side control circuit 52 monitors the recharge state of the battery 94, as indicated by A12. Specifically, the power-reception-side control circuit 52 monitors and determines whether or not the battery 94 requires recharging. Or, the power-reception-side control circuit 52 may monitor the battery voltage VBAT and transmit information relating to the battery voltage VBAT to the power transmission device 10. The power-reception-side control circuit 52 monitors the recharge state of the battery 94 based on the monitoring result of the recharge monitoring circuit 64.

At B1 in FIG. 5B, the power-reception-side control circuit 52 transmits the recharge command which indicates information relating to the recharge state of the battery 94 to the power transmission device 10. For example, when the power-reception-side control circuit 52 has determined that the battery 94 requires recharging based on the monitoring result of the recharge monitoring circuit 64, the power-reception-side control circuit 52 transmits the recharge command to the power transmission device 10. When the power-transmission-side control circuit 22 has received the recharge command from the power reception device 40, the power-transmission-side control circuit 22 resets the full-charge flag FC to 0, as indicated by B2, and resumes normal power transmission to the power reception device 40, as indicated by B3. Specifically, the power-transmission-side control circuit 22 resumes normal power transmission when the power-transmission-side control circuit 22 has determined that the battery 94 requires recharging based on the recharge command. This causes recharging of the battery 94 to start so that the battery 94 of which the voltage has decreased can be recharged.

4. Detailed Operation

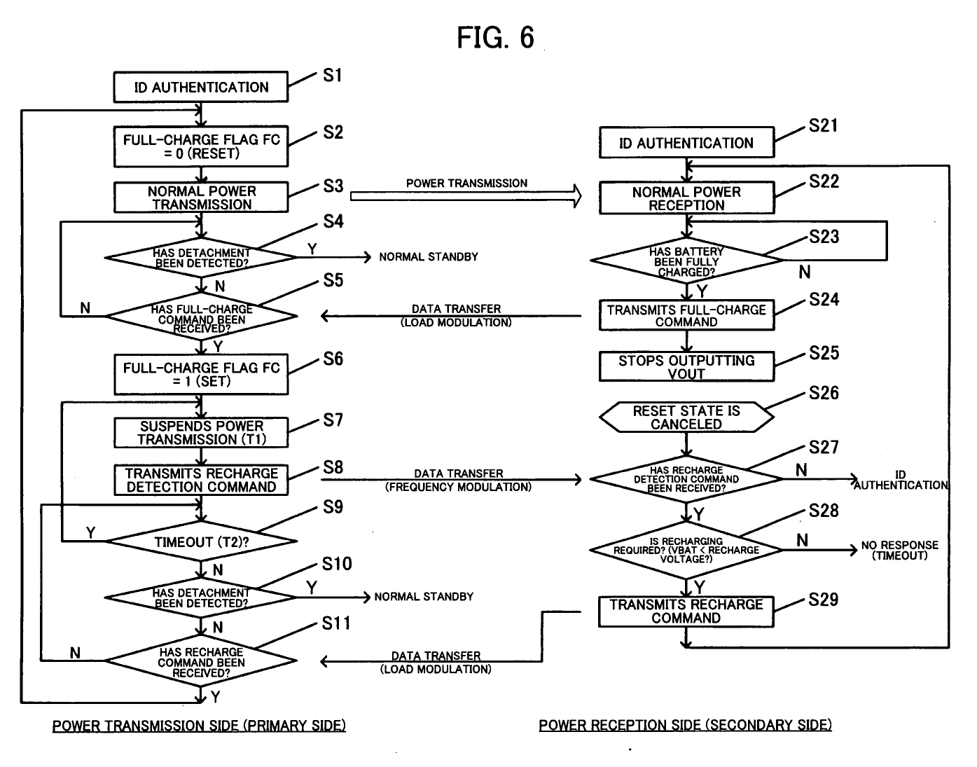

A detailed operation example according to this embodiment is described below with reference to a flowchart shown in FIG. 6. The power-transmission-side process is as follows.

When the power-transmission-side instrument (primary-side instrument) has completed ID authentication with regard to the power-reception-side instrument (secondary-side instrument), the power-transmission-side instrument resets the full-charge flag FC to 0 (steps S1 and S2). The power-transmission-side instrument then starts normal power transmission to the power-reception-side instrument (step S3). The power-transmission-side instrument then performs detachment detection (step S4). When the power-transmission-side instrument has detected detachment, the power-transmission-side instrument transitions to the normal standby mode. Specifically, the power-transmission-side instrument detects detachment when the portable telephone 510 has been physically separated from the charger 500 in FIG. 1A so that a magnetic flux of the primary coil L1 does not pass through the secondary coil L2, and then transitions to the normal standby mode. In the normal standby mode, the power-transmission-side instrument does not perform intermittent power transmission, differing from the post-full-charge standby mode. The power-transmission-side instrument completely suspends power transmission until the portable telephone 510 is again placed on the charger 500.

The power-transmission-side instrument determines whether or not the full-charge command has been received from the power-reception-side instrument (step S5). When the power-transmission-side instrument has determined that the full-charge command has not been received from the power-reception-side instrument, the power-transmission-side instrument returns to the step S4. When the power-transmission-side instrument has determined that the full-charge command has been received from the power-reception-side instrument, the power-transmission-side instrument sets the full-charge flag FC at 1 (step S6). The power-transmission-side instrument then suspends power transmission to the power-reception-side instrument during the first period T1 (step S7). The period T1 is measured by a count process based on a power-transmission-side clock signal.

When the first period T1 has expired, the power-transmission-side instrument resumes power transmission (intermittent power transmission), and transmits the recharge detection command to the power-reception-side instrument (step S8). Specifically, the power-transmission-side instrument generates a frame which instructs detection of the recharge state, and transmits the generated frame to the power-reception-side instrument by frequency modulation. The power-transmission-side instrument waits for the second period T2 to expire (i.e., timeout to occur) (step S9). Specifically, the power-transmission-side instrument waits for the power-reception-side instrument to operate upon cancellation of the reset state due to intermittent power transmission and transmit the recharge command. The power-transmission-side instrument performs detachment detection until the second period T2 expires (step S11). When the power-transmission-side instrument has detected detachment, the power-transmission-side instrument transitions to the normal standby mode. The power-transmission-side instrument monitors whether or not the recharge command has been received from the power-reception-side instrument until the second period T2 expires (step S11). When the power-transmission-side instrument has not received the recharge command from the power-reception-side instrument, the power-transmission-side instrument returns to the step S9. When the second period T2 has expired (i.e., timeout has occurred), the power-transmission-side instrument returns to the step S7, and again suspends power transmission to the power-reception-side instrument. The power-transmission-side instrument performs intermittent power transmission after the power transmission suspension period T1 has expired, and again transmits the recharge detection command to the power-reception-side instrument (step S8). As described above, the power-transmission-side instrument repeatedly suspends power transmission and performs intermittent power transmission until the power-transmission-side instrument receives the recharge command from the power-reception-side instrument.

When the power-transmission-side instrument has received the recharge command from the power-reception-side instrument in the step S11, the power-transmission-side instrument returns to the step S2, and resets the full-charge flag FC to 0. The power-transmission-side instrument the resumes normal power transmission for recharging the battery 94 (step S3). This causes the battery 94 of which the voltage has decreased to be recharged.

The power-reception-side process is as follows. When the power-transmission-side instrument has completed ID authentication, the power-reception-side instrument starts normal power reception (steps S21 and S22). The power-reception-side instrument then determines whether or not the battery 94 has been fully charged. When the battery 94 has been fully charged, the power-reception-side instrument transmits the full-charge command to the power-transmission-side instrument (steps S23 and S24). Specifically, the power-reception-side instrument generates a frame which indicates that the battery 94 has been fully charged, and transmits the generated frame to the power-transmission-side instrument by load modulation. The power-transmission-side instrument sets the full-charge flag FC at 1, and suspends power transmission (steps S6 and S7). The power-reception-side instrument stops outputting the voltage VOUT to the charge control device 92 (step S25). Specifically, the power-reception-side instrument causes the transistors TB2 and TB1 shown in FIG. 2 to be turned OFF to electrically disconnect the load 90. More specifically, the control circuit 52 causes the transistor TB2 to be turned OFF by setting the signal P1Q at the H level. The output assurance circuit 54 (open-drain N-type transistor) sets the signal P4Q in a high impedance state to set the nodes NB7 and NB9 at the same potential so that the transistor TB1 is turned OFF. This enables the transistor TB1 to be reliably turned OFF even when power is not supplied to the power reception device 40.

When the power-transmission-side instrument has suspended power transmission in the step S7 in FIG. 6, the power-reception-side instrument is reset since power is not supplied to the power-reception-side instrument. When the power-transmission-side instrument has then started intermittent power transmission, power is supplied to the power-reception-side instrument. Therefore, the power-reception-side power supply voltage rises, whereby the reset state is canceled (step S26). The power-reception-side instrument then determines whether or not the power-reception-side instrument has received the recharge detection command (step S27). When the power-reception-side instrument has not received the recharge detection command, the power-reception-side instrument transitions to a normal ID authentication process. Specifically, a normal standby mode process is performed.

When the power-reception-side instrument has received the recharge detection command, the power-reception-side instrument determines whether or not the battery 94 requires recharging (step S28). Specifically, the power-reception-side instrument determines whether or not the battery voltage VBAT is lower than the recharge voltage (e.g., 3.9 V). When the power-reception-side instrument has determined that the battery 94 does not require recharging, the power-reception-side instrument does not respond to the power-transmission-side instrument. Therefore, the power-transmission-side instrument determines that a timeout has occurs in the step S9, and again suspends power transmission so that the power-reception-side instrument is reset.

When the power-reception-side instrument has determined that the battery 94 requires recharging in the step S28, the power-reception-side instrument transmits the recharge command (step S29). When the power-transmission-side instrument has received the recharge command, the power-transmission-side instrument resets the full-charge flag FC to 0 and resumes normal power transmission (steps S2 and S3). The power-reception-side instrument also resumes normal power reception (step S22) so that the post-full-charge standby mode is canceled.

According to this embodiment, when the power-reception-side instrument has detected that the battery 94 has been fully charged, the power-transmission-side instrument suspends power transmission (step S7). The power-reception-side instrument stops outputting the voltage VOUT to the charge control device 92 (step S25), and transitions to the post-full-charge standby mode. In the post-full-charge standby mode, since the power-transmission-side instrument suspends power transmission, the power reception control device 50 is reset. Moreover, since the power-reception-side instrument stops outputting the voltage VOUT, the charge control device 92 is also reset. Therefore, a standby current which flows through the power reception control device 50 and the charge control device 92 can be significantly reduced, whereby power consumption can be reduced.

According to the comparative example method, power transmission from the power-transmission-side instrument to the power-reception-side instrument is not suspended after the full-charge state has been detected, and the charge control device 92 operates based on the output voltage VOUT. Therefore, the comparative example method cannot significantly reduce the standby current which flows through the power reception control device 50 and the charge control device 92. According to this embodiment, since power transmission from the power-transmission-side instrument to the power-reception-side instrument is intermittently suspended in the post-full-charge standby mode, the standby current can be significantly reduced.

According to this embodiment, after the power-reception-side instrument has been reset, the power-transmission-side instrument performs intermittent power transmission and transmits the recharge detection command (step S8). The power-reception-side instrument monitors the recharge state based on the received recharge detection command when the reset state has been canceled (steps S27 and S28). When the power-reception-side instrument has determined that recharging is necessary, the power-reception-side instrument transmits the recharge command (step S29).

Specifically, since the power-reception-side instrument is reset when power transmission has been suspended, the power-reception-side instrument cannot store information relating to the full-charge state or the recharge state. On the other hand, the power-transmission-side instrument can store such information. This embodiment focuses on this point. Specifically, the power-transmission-side instrument transmits the recharge detection command to the power-reception-side instrument in the intermittent power transmission period after power transmission has been suspended. This enables the power-reception-side instrument released from the reset state to start monitoring the recharge state based on the recharge detection command from the power-transmission-side instrument as a trigger, even if the power-reception-side instrument does not store the information relating to the full-charge state or the recharge state. When the power-reception-side instrument has determined that recharging is necessary, the power-reception-side instrument can notify the power-transmission-side instrument that recharging is necessary by transmitting the recharge command. This makes it possible to appropriately recharge the battery 94 after the battery 94 has been fully charged.

When the power-transmission-side instrument has not received the recharge command within the period T2 so that a timeout has occurred, the power-transmission-side instrument again suspends power transmission (steps S9 and S7). Specifically, the power-transmission-side instrument repeatedly suspends power transmission and performs intermittent power transmission until the power-transmission-side instrument receives the recharge command. Therefore, it suffices that the power-reception-side instrument operate only in the intermittent power transmission period. The standby current in the post-full-charge standby mode can be significantly reduced by sufficiently increasing the power transmission suspension period T1. Therefore, the battery 94 can be optimally recharged while minimizing unnecessary power consumption.

In FIG. 6, the full-charge flag FC is reset after ID authentication between the power-transmission-side instrument (power transmission device) and the power-reception-side instrument (power reception device) has been completed, and normal power transmission to the power-reception-side instrument is then started (steps S2 and S3). When the power-transmission-side instrument has received the full-charge command from the power-reception-side instrument, the power-transmission-side instrument sets the full-charge flag FC (step S6). When the power-transmission-side instrument resumes normal power transmission for recharging the battery 94, the power-transmission-side instrument resets the full-charge flag FC (step S2). According to this configuration, the power-transmission-side instrument which can store the information relating to the full-charge flag FC when power transmission is suspended can appropriately control the sequence when the battery has been fully charged or is recharged using the information relating to the full-charge flag FC.

5. Waveform Detection Circuit and Voltage Monitoring Circuit

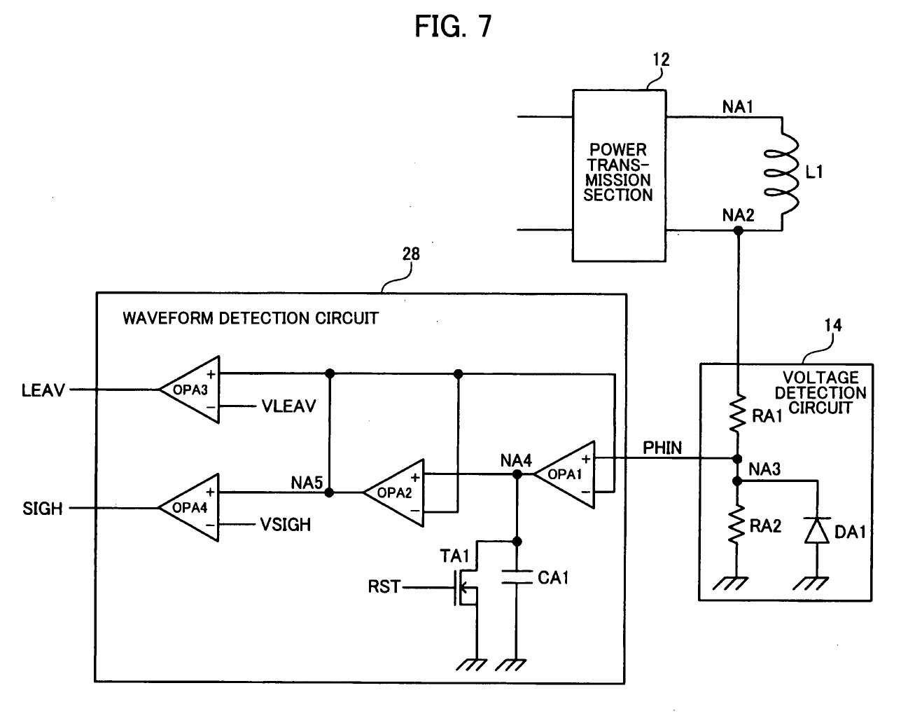

FIG. 7 shows a configuration example of the power-transmission-side waveform detection circuit 28. The waveform detection circuit 28 includes operational amplifiers OPA1 to OPA4 (comparators), a capacitor CA1, and a reset N-type transistor TA1.

In FIG. 7, the operational amplifiers OPA1 and OPA2, the capacitor CA1, and the transistor TA1 form a peak detection circuit. Specifically, the peak voltage of the detection signal PHIN from the voltage detection circuit 14 is held by the node NA4, and the peak voltage signal held by the hold node NA4 is subjected to impedance conversion by the voltage-follower-connected operational amplifier OPA2 and is output to the node NA5. The peak voltage signal held by the node NA4 is reset by the transistor TA1.

The operational amplifier OPA4 which forms a data detection circuit compares the peak voltage signal at the node NA5 with a data detection threshold voltage VSIGH, and outputs a data signal SIGH (“0” or “1”). The operational amplifier OPA3 which forms a detachment detection circuit compares the peak voltage signal at the node NA5 with a detachment detection threshold voltage VLEAV, and outputs a detachment detection signal LEAV. The configuration of the waveform detection circuit 28 is not limited to the configuration shown in FIG. 7. Various modification may be made such as omitting some elements or adding another element.

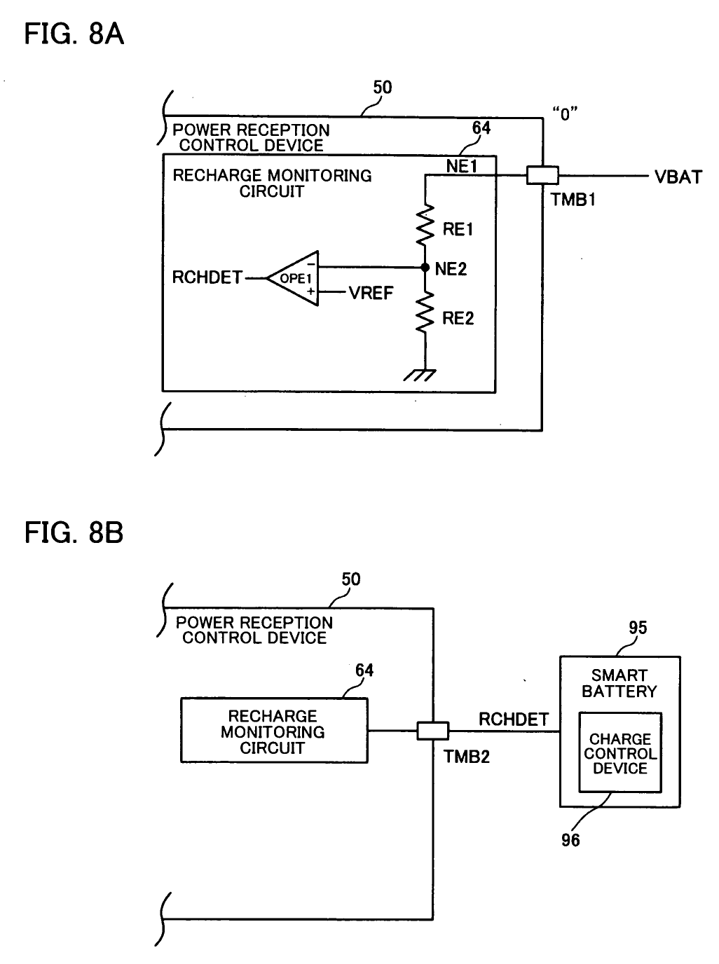

FIG. 8B shows a configuration example of the recharge monitoring circuit 64. The recharge monitoring circuit 64 includes resistors RE1 and RE2 provided in series between a battery voltage VBAT input node NE1 and a power supply GND (low-potential-side power supply), and an operational amplifier OPE1 (comparator). A connection node NE2 of the resistors RE1 and RE2 is connected to an inverting input terminal of the operational amplifier OPE1, and a reference voltage VREF is input to a non-inverting input terminal of the operational amplifier OPE1. In FIG. 8B, when the battery voltage VBAT has become lower than the recharge voltage (3.9 V) and the voltage of the node NE2 has become lower than the reference voltage VREF, a recharge detection signal RCHDET output from the operational amplifier OPE1 becomes active (H level).

In FIG. 8A, the power reception control device 50 (power reception control IC) has a terminal TMB1 (pad) to which the battery voltage VBAT for monitoring the recharge state of the battery is input. It is possible to monitor the battery voltage VBAT to detect whether or not the battery 94 requires recharging by providing the terminal TMB1.

The recharge monitoring circuit 64 is not limited to the configuration shown in FIG. 8A. In FIG. 8B, the charge target battery is a smart battery 95, for example. The smart battery 95 includes a charge control device 96 (charge control circuit) which has the same function as that of the charge control device 92 shown in FIG. 4. The charge control device 96 detects whether or not the smart battery 95 which has been fully charged requires recharging. When the charge control device 96 has detected that the smart battery 95 requires recharging, the charge control device 96 activates the recharge detection signal RCHDET. The recharge monitoring circuit 64 of the power reception control device 50 according to this embodiment monitors (buffers) the recharge detection signal RCHDET, and notifies the control circuit 52 of the power reception control device 50 that the recharge detection signal RCHDET has become active. This enables the recharge state to be monitored effectively utilizing the function of the smart battery 95.

In FIG. 8B, the power reception control device 50 (power reception control IC) has a terminal TMB2 (pad) to which the detection signal RCHDET from the smart battery 95 is input. The detection signal RCHDET can be input to the power reception control device 50 from the smart battery 95 by providing the terminal TMB2 so that the recharge state of the smart battery 95 can be monitored.

6. Modification

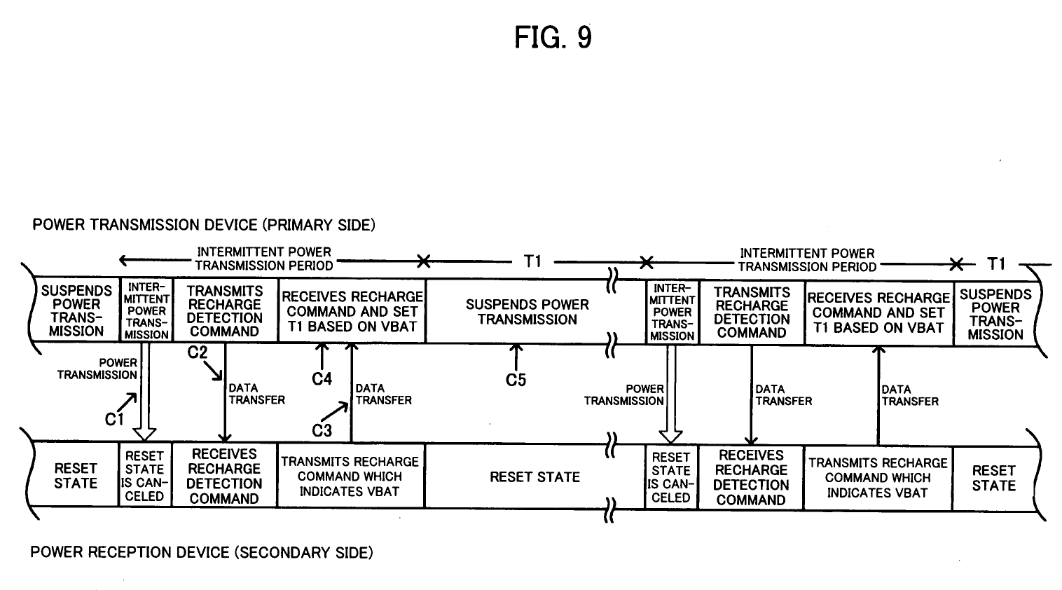

A modification according to this embodiment is described below with reference to FIG. 9. According to the recharging method shown in FIG. 5A, the power-transmission-side instrument transmits the recharge detection command to the power-reception-side instrument, as indicated by A6, and waits for reception of the recharge command from the power-reception-side instrument until the timeout period T2 expires, for example. When the power-transmission-side instrument has not received the recharge command within the period T2, the power-transmission-side instrument suspends power transmission during the period T1, as indicated by A8. When the power-transmission-side instrument has received the recharge command within the period T2, as indicated by B1 in FIG. 5B, the power-transmission-side instrument resumes normal power transmission, as indicated by B3.

According to the modification shown in FIG. 9, the power-transmission-side instrument performs intermittent power transmission, as indicated by C1, and then transmits the recharge detection command to the power-reception-side instrument, as indicated by C2. The power-reception-side instrument which has received the recharge detection command transmits the recharge command (recharge information command) which indicates the battery voltage VBAT to the power-transmission-side instrument, as indicated by C3. Specifically, the power-reception-side instrument generates a frame of the recharge command which indicates the value of the battery voltage VBAT or the degree of the battery voltage VBAT, and transmits the generated frame to the power-transmission-side instrument.

The power-transmission-side instrument receives the recharge command, and sets the power transmission suspension period T1 based on the battery voltage VBAT indicated by the recharge command. Specifically, the power-transmission-side instrument changes the period T1 based on the battery voltage VBAT. More specifically, the power-transmission-side instrument increases the power transmission suspension period T1 when the battery voltage VBAT has not decreased to a large extent, and decreases the power transmission suspension period T1 as the battery voltage VBAT approaches the recharge voltage (voltage at which recharging is necessary), for example.

According to the modification shown in FIG. 9, the power transmission suspension period T1 can be optimally controlled corresponding to the battery voltage VBAT indicated by the recharge command. Therefore, the battery can be efficiently recharged while minimizing unnecessary power consumption. Specifically, when the battery voltage VBAT has not decreased to a large extent, the reset period of the power reception control device 50 and the charge control device 92 can be sufficiently increased by sufficiently increasing the power transmission suspension period T1, whereby power consumption can be reduced by reducing the standby current to a large extent. On the other hand, when the battery voltage VBAT approaches the recharge voltage, the power transmission suspension period T1 is reduced so that the battery voltage VBAT is monitored frequently. This makes it possible to start recharging using an accurate recharge voltage. This prevents a situation in which recharging does not occur even if the recharge voltage has been reached, whereby appropriate recharging is achieved.

Although the embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term (e.g., GND and portable telephone/charger) cited with a different term (e.g., low-potential-side power supply and electronic instrument) having a broader meaning or the same meaning at least once in the specification and the drawings can be replaced by the different term in any place in the specification and the drawings. The invention also includes any combination of the embodiments and the modifications. The configurations and the operations of the power transmission control device, the power transmission device, the power reception control device, and the power reception device, the full-charge state/recharge (necessary) state detection method, and the recharging method are not limited to those described relating to the above embodiments. Various modifications and variations may be made. For example, the full-charge state or the recharge state of the battery may be detected or the battery may be recharged using a sequence differing from those shown in FIGS. 5A, 5B, 6, and 9.

What is claimed is:

1. A power transmission control device provided in a power transmission device of a non-contact power transmission system, the non-contact power transmission system transmitting power from the power transmission device to a power reception device by electromagnetically coupling a primary coil and a secondary coil to transmit the power to a load of the power reception device, the power transmission control device comprising:
a power-transmission-side control circuit that controls the power transmission device,
when the power-transmission-side control circuit has detected that a battery included in the load has been fully charged, the power-transmission-side control circuit performing control of suspending normal power transmission to the power reception device and control of performing intermittent power transmission, and, when the power-transmission-side control circuit has detected that the battery requires recharging during an intermittent power transmission period, the power-transmission-side control circuit performing control of resuming the normal power transmission to the power reception device.

2. The power transmission control device as defined in claim 1,
the power-transmission-side control circuit performing control of suspending power transmission to the power reception device during a first period when the power-transmission-side control circuit has received a full-charge command from the power reception device during the normal power transmission to the power reception device, the full-charge command indicating that the battery has been fully charged, and performing control of transmitting a recharge detection command to the power reception device during the intermittent power transmission period after resuming power transmission, the recharge detection command instructing the power reception device to detect a recharge state of the battery.

3. The power transmission control device as defined in claim 2,
when the power-transmission-side control circuit has received a recharge command that indicates information relating to the recharge state of the battery from the power reception device and determined that the battery requires recharging, the power-transmission-side control circuit performing control of resuming the normal power transmission to the power reception device.

4. The power transmission control device as defined in claim 3,
the power-transmission-side control circuit performing control of suspending power transmission to the power reception device during the first period when the power-transmission-side control circuit has not received the recharge command from the power reception device until a second period has expired after transmitting the recharge detection command to the power reception device, and performing control of transmitting the recharge detection command to the power reception device during the intermittent power transmission period after resuming power transmission.

5. The power transmission control device as defined in claim 2,
the power-transmission-side control circuit performing control of resetting a full-charge flag and starting the normal power transmission to the power reception device after ID authentication between the power transmission device and the power reception device has been completed, setting the full-charge flag when the power-transmission-side control circuit has received the full-charge command from the power reception device, and resetting the full-charge flag when resuming the normal power transmission to recharge the battery.

6. A power reception control device provided in a power reception device of a non-contact power transmission system, the non-contact power transmission system transmitting power from a power transmission device to the power reception device by electromagnetically coupling a primary coil and a secondary coil to transmit the power to a load of the power reception device, the power reception control device comprising:
a power-reception-side control circuit that controls the power reception device; and
a recharge monitoring circuit that monitors a recharge state of a battery included in the load after the battery has been fully charged,
when the battery has been fully charged and the power transmission device has suspended normal power transmission and performed intermittent power transmission, the power-reception-side control circuit performing control of transmitting a recharge command to the power transmission device in an intermittent power transmission period, the recharge command indicating information relating to the recharge state of the battery.

7. The power reception control device as defined in claim 6,
the power reception control device further including a full-charge detection circuit that detects whether or not the battery has been fully charged,
when the battery has been fully charged, the power-reception-side control circuit performing control of transmitting a full-charge command that indicates that the battery has been fully charged to the power transmission device, and stopping outputting a voltage to a charge control device that controls charging the battery.

8. The power reception control device as defined in claim 7,
the power reception control device being reset when power transmission from the power transmission device has been suspended after transmitting the full-charge command; and
when the power-reception-side control circuit has received a recharge detection command from the power transmission device after a reset state of the power reception control device has been canceled by intermittent power transmission from the power transmission device, the recharge detection command instructing the power reception device to detect the recharge state of the battery, the power-reception-side control circuit monitors the recharge state of the battery.

9. The power reception control device as defined in claim 6,
the power reception control device further including a terminal, a battery voltage or a detection signal for monitoring the recharge state of the battery being input to the terminal.

10. A non-contact power transmission system comprising a power transmission device and a power reception device, the non-contact power transmission system transmitting power from the power transmission device to the power reception device by electromagnetically coupling a primary coil and a secondary coil to transmit the power to a load of the power reception device,
the power transmission device including a power-transmission-side control circuit that controls the power transmission device;
the power reception device including:
a power-reception-side control circuit that controls the power reception device;
a full-charge detection circuit that detects whether or not the battery has been fully charged; and
a recharge monitoring circuit that monitors a recharge state of the battery after the battery has been fully charged;
when the battery has been fully charged, the power-reception-side control circuit performing control of transmitting a full-charge command that indicates that the battery has been fully charged to the power transmission device, and stopping outputting a voltage to a charge control device that controls charging the battery;
when the power-transmission-side control circuit has received the full-charge command from the power reception device during normal power transmission to the power reception device, the power-transmission-side control circuit performing control of suspending power transmission to the power reception device during a first period, and performing control of transmitting a recharge detection command to the power reception device during an intermittent power transmission period after resuming power transmission, the recharge detection command instructing the power reception device to detect the recharge state of the battery; and
the power-reception-side control circuit performing control of receiving the recharge detection command in the intermittent power transmission period, and performing control of transmitting a recharge command that indicates information relating to the recharge state of the battery to the power transmission device.

11. The non-contact power transmission system device as defined in claim 10,
the power-transmission-side control circuit performing control of suspending power transmission to the power reception device during the first period when the power-transmission-side control circuit has not received the recharge command from the power reception device until a second period has expired after transmitting the recharge detection command to the power reception device, and performing control of transmitting the recharge detection command to the power reception device during an intermittent power transmission period after resuming power transmission.

12. A power transmission device comprising:
the power transmission control device as defined in claim 1; and
a power transmission section that generates an alternating-current voltage and supplies the alternating voltage to the primary coil.

13. A power reception device comprising:
the power reception control device as defined in claim 6; and
a power receiving section that converts an induced voltage in the secondary coil into a direct voltage.

14. An electronic instrument comprising the power transmission device as defined in claim 12.

15. An electronic instrument comprising:
the power reception device as defined in claim 13; and
a load, power being supplied to the load from the power reception device.
